(19) United States
(12) Patent Application Publication
(10) Pub. No.: US 2022/0382806 A1
(43) Pub. Date: Dec. 1, 2022

(54) MUSIC ANALYSIS AND RECOMMENDATION ENGINE

(71) Applicants: Michael A. Liberty, Windermere, FL (US); Riley J. Liberty, Windermere, FL (US); John R. Wright, Windermere, FL (US); Johnny Wright, Orlando, FL (US)

(72) Inventors: Michael A. Liberty, Windermere, FL (US); Riley J. Liberty, Windermere, FL (US); John R. Wright, Windermere, FL (US); Johnny Wright, Orlando, FL (US)

(21) Appl. No.: 17/752,488

(22) Filed: May 24, 2022

Related U.S. Application Data
(60) Provisional application No. 63/192,827, filed on May 25, 2021.

(51) Int. Cl. G06F 16/683; G06V 10/82; G06V 10/74

(52) U.S. Cl. CPC G06F 16/685; G06V 10/82; G06V 10/761

(57) ABSTRACT

A music analysis and recommendation system (“the system”) is configured to receive and analyzing data associated with a song performed by a performer. The system also accesses a current contextual information repository to identify a current cultural paradigm and maps the current cultural paradigm to a historical contextual information repository to identify one or more historical periods that have a cultural paradigm matching the current cultural paradigm. The system then identifies one or more hit songs during the one or more historical periods and retrieves data associated with the one or more hit songs. The data associated with the song performed by the performer is compared with data associated with each of the hit songs to determine a similarity. Based upon the determined similarities, the system determines a likelihood of the song becoming a hit song and/or a likelihood of the performer becoming a hit song performer.

### CROSS-REFERENCE TO RELATED APPLICATIONS

This application claims the benefit of and priority to U.S. Provisional Patent Application Ser. No. 63/192,827 filed on 25 May 2021 and entitled “MUSIC ANALYSIS AND RECOMMENDATION ENGINE,” which application is expressly incorporated herein by reference in its entirety.

### BACKGROUND

In the current music industry, there are many songs performed by many different performers. Some of these songs performed by particular performers become hits. Yet, some of these songs never become hits, and some of these performers never become hit song performers.

Generally, the ultimate goal of the songwriters and performers is to create hit songs. However, there is little guidance on how to create hit songs. These songwriters often depend on their gut feelings and past experiences when they write the lyrics, melodies, and/or adaptations of their songs. The songwriters also often depend on their gut feelings and/or their past relationships when they pick a particular performer to perform their songs. A songwriter who writes lyrics and a songwriter who writes melodies also get paired based on their gut feelings and/or their past relationships. Sometimes the gut feelings are correct, and sometimes the gut feelings are incorrect. There is no systematic method for songwriters and/or performers (especially true for the new or unknown songwriters and/or performers) to improve their likelihood of creating a hit song or becoming a hit song performer.

In the internet era, even though unknown songwriters and unknown performers may use social media, online video hosting platforms, and personal web pages to promote themselves and their songs, it is still difficult to get unknown artists noticed by established songwriters and established performers, especially when a songwriter is good at writing lyrics, but not good at writing melodies, or vice versa, or when an artist is a good performer, but not a good songwriter, or vice versa.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to a music analysis and recommendation engine implemented at a computing system (hereinafter, also referred to as “the computing system” or “the engine”) and a method for analyzing and classifying existing songs, predicting a likelihood of new songs becoming a hit, and providing suggestions to performers and/or authors.

The computing system receives data associated with a song (e.g., a new song) performed by a performer (e.g., a new performer). The data includes at least one of (1) a performer picture, (2) a performer video, (3) lyrics of the song, or (4) audio of the song. The audio of the song is transformed into a frequency representation, representing a frequency spectrum of the audio. The lyrics of the song is transformed into a text vector via natural language processing (NLP).

Further, the computing system accesses a current contextual information repository (e.g., a news repository, social media, blogs) to identify a current cultural paradigm. For example, a cultural paradigm may be a civil rights movement, a Black Lives Matter movement, an LGBTQ movement, a feminist movement, or an anti-war movement. The computing system also accesses a historical contextual information repository to identify one or more historical periods that match the current cultural paradigm. The computing system then retrieves data associated with one or more hit songs during the one or more historical periods. For each of the one or more hit songs, the data associated with the hit song includes at least one of (1) a performer picture, (2) a performer video, (3) lyrics of the hit song, or (4) audio of the hit song.

For each of the hit songs, the computing system transforms the audio of the hit song into a frequency representation, representing a frequency spectrum of the audio, and transform the lyrics of the hit song into a text vector via the natural language processing. Further, the computing system compares the frequency representation of the song with the frequency representation of the hit song to determine a similarity between the audio of the song and the audio of the hit song. Moreover, the computing system compares the text vector of the song and the text vector of the hit song to determine a similarity between the lyrics of the song and the lyrics of the hit song. Based upon the similarities between the audio and/or lyrics of the song and those of the hit songs, the computing system determines at least one of (1) a likelihood of the music audio of the song becoming hit song music; or (2) a likelihood of the lyrics of the song becoming hit song lyrics.

In some embodiments, the determination of the likelihood the song becoming a hit song includes determining a first likelihood of the song becoming a hit song based upon the similarities between the audio of the song and the audio of the hit songs; and determining a second likelihood of the song becoming a hit song based upon similarities between the lyrics of the song and the lyrics of the hit songs. The computing system may then assign a weight to each of the first likelihood and the second likelihood, and weight the first likelihood and the second likelihood based upon the assigned weights to determine (1) the likelihood of the music audio of the song becoming hit song music; or (2) the likelihood of the lyrics of the song becoming hit song lyrics.

In some embodiments, the computing system also determines a relatedness between the lyrics of the song and the current cultural paradigm indicating contextual influence. The computing system may also assign a weight to a contextual influence of the relatedness and weight each of the first likelihood, the second likelihood, and the contextual influence of the relatedness to determine (1) the likelihood of the music audio of the song becoming hit song music; or (2) the likelihood of the lyrics of the song becoming hit song lyrics.

In some embodiments, the computing system is further caused to classify the lyric of the song to a particular category (also referred to as a first particular category) of a plurality of categories based upon the text vector of the song and a trained machine learning lyric classifier model. For example, the plurality of categories may be different known genres. The computing system then identifies one or more hit songs that belong to the particular category, and compares the song with the one or more hit songs that belong to the particular category. In some embodiments, the computing system also trains the machine learning lyrics classifier model using data associated with a set of known songs. For each song of the set of known songs, the data associated with the song includes lyrics of the song and a corresponding category of the plurality of categories that the song belongs to.

In some embodiments, the computing system may also classify the audio of the song to a particular category (also referred to as a second category) based upon the frequency spectrum of the song and a trained machine learning audio classifier model. The computing system may also identify one or more hit songs that belong to the particular category and compares the song with the identified one or more hit songs that belong to the particular category. In some embodiments, the computing system also trains the machine learning audio classifier model using data associated with a set of known songs. For each song of the set of known songs, the data associated with the song includes audio of the song and a corresponding category of the plurality of categories that the song belongs to.

It is advantageous to classify songs to different categories or genres and compare the received song only with the songs that belong to the same genre, because songs and performers that belong to different genres may have very different features and characters. Thus, comparing a song and a hit song in a same genre may provide more meaningful indications whether the song is likely to become a hit song.

In some embodiments, when the first particular category and the second particular category do not match, the computing system may suggest an alternative genre or an alternative adaptations for music of the song.

In some embodiments, the computing system further transforms the performer picture into an image vector using a convolutional network (also referred to as a first convolutional network). For each of the identified one or more hit songs, the computing system transforms a performer picture of the hit song into an image vector using the first convolutional network and compares the image vector of the performer picture and image vector of each hit song performer picture to determine a similarity between the performer and each hit song performer. Based upon the determined similarities between the performer and the hit song performers, the computing system determines a likelihood (also referred to as a third likelihood) of the performer becoming a hit song performer.

The video of the performer includes a sequence of images. In some embodiments, the computing system further transforms the sequence of images into a sequence of image vectors using a convolutional network (also referred to as a second convolutional network). For each of the identified one or more hit songs, the computing system also transforms a performer video of the hit song performer into a sequence of image vectors using the second convolutional network and compares the sequence of the image vectors of the performer video and the sequence of the image vectors of the hit song performer video to determine a similarity between emotion of the performer and emotion of the hit song performer. Based upon the determined similarity between the performer video and each hit song performer video, the computing system determines a likelihood (also referred to as a fourth likelihood) of the performer becoming a hit song performer.

In some embodiments, the computing system also assigns each of the third likelihood and the fourth likelihood of the performer becoming a hit song performer a weight and weights the third likelihood and the fourth likelihood based upon the assigned weights to determine an overall likelihood of the performer becoming a hit song performer of the song.

In some embodiments, the computing system also classifies the performer image to a particular category (also referred to a third particular category) of the plurality of categories based upon the image vector of the performer image and a trained machine learning image classifier model. The computing system also identifies one or more hit songs that belong to the particular category. The image vector of the performer image is compared with an image vector of each of the one or more hit songs that belong to the same category to determine a similarity, which is then used to determine the third likelihood of the performer becoming a hit song performer. In some embodiments, the computing system also trains the machine learning image classifier model using data associated with a set of known songs. For each song of the set of known songs, the data associated with the song includes a performer image of the hit song performer and a corresponding category of the plurality of categories that the song belongs to.

In some embodiments, the computing system also classifies the performer video of the performer to a particular category (also referred to as a third category) of the plurality of categories based upon the sequence of image vectors and a trained machine learning video classifier model. The computing system also identifies one or more hit songs that belong to the particular category and compares the sequence of image vectors with a sequence of image vectors of each of the one or more hit songs to determine a similarity, which is then used to determine the fourth likelihood of the performer becoming a hit song performer. In some embodiments, the computing system also trains the machine learning video classifier model using data associated with a set of known songs. For each song of the set of known songs, the data associated with the song includes a performer video of the song and a corresponding category of the plurality of categories that the song belongs to.

In some embodiments, the computing system is further configured to suggest one or more changes to the performer's appearance, facial expression, emotion, and/or body movement to increase the likelihood of the performer becoming a hit song performer of the song. In some embodiments, the computing system is also configured to suggest an alternative performer or one or more changes to an adaptations of the song to increase the likelihood of the song becoming a hit song when the overall likelihood of the performer becoming a hit song performer is lower than a predetermined threshold. In some embodiments, the computing system analyzes the audio of the song to determine a vocal range of melody of the song. The computing system then identifies one or more alternative song performers in the same genre who have a vocal range that covers the vocal range of the melody of the song and suggests at least one of the identified one or more alternative song performers as an alternative performer.

In some embodiments, the computing system is further configured to suggest one or more changes to the lyrics or melody of the song to increase the likelihood of the song becoming a hit song. In some embodiments, the suggestion of the one or more changes to the lyrics is based upon the current contextual information, suggesting one or more words to be included in the lyrics. Similarly, when the third particular category and the fourth particular category do not match, additional suggestions may be provided to the appearance, facial expression, and/or movement of the performer.

In some embodiments, the computing system is further configured to receive a user input of a genre and identifies one or more current hit songs that belong to the genre. The computing system then retrieves data associated with the identified one or more current hit songs. For each of the identified one or more hit songs, data associated with the hit song includes at least one of (1) a performer picture, (2) a performer video, (3) lyrics of the hit song, or (4) audio of the hit song. In some embodiments, the computing system analyzes the lyrics of the one or more hit songs to identify common words or phrases and/or analyzes the audio of the one or more hit songs to identify common melody patterns. Based upon the identified common words or phrases, the common melody patterns, and/or the current cultural paradigm, the computing system suggests at least one of the following to the user: (1) a list of words or phrases that may be included in a new song, (2) one or more portions of a melody that may be included in the new song, and/or (3) a list of candidate performers that may be considered to be a performer of the new song.

In some embodiments, the computing system is further configured to determine a consumer sector for the particular category of the song or the performer based upon the contextual information. Based upon the determined consumer sector, the computing system is capable of suggesting at least one of the following changes: (1) one or more changes to the lyrics of the song, (2) one or more changes to melody of the song, (3) one or more changes to the appearance of the performer, (4) one or more changes to movements of the performer, (5) one or more changes to facial expression of the performer; or (6) replacing the performer with a different performer.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates a diagram of a general principle of a music analysis and recommendation engine embodying the principles described herein;

FIG. 2 illustrates a flowchart of an example process that the music analysis and recommendation engine of FIG. 1 may perform;

FIG. 3A through 3E break down the flowchart of FIG. 2, providing additional details of each act illustrated in FIG. 2;

FIG. 4 illustrates an example embodiment of using natural language processing to implement a supervised machine learning process to generate a lyrics classifier model for classifying lyrics into a plurality of genres;

FIG. 5 illustrates an example embodiment of using a convolutional network to implement a supervised machine learning process to generate an image classifier model and/or a video classifier model for classifying performer images and/or performer videos into a plurality of genres;

FIG. 6 illustrates an example of an artificial neural network, which may be used in the machine learning process of FIG. 4 and/or FIG. 5 to train the lyrics classifier model, the image classifier model, and/or the video classifier model;

FIG. 7 illustrates an example embodiment of pre-processing and transforming audio data of songs into a spectrogram;

FIG. 8 illustrates an example embodiment of mapping a song to one of a plurality of cultural paradigms and/or one of a plurality of consumer sectors;

FIG. 9 illustrates an example architecture of the music analysis and recommendation engine;

FIGS. 10A and 10B illustrate a continuous flowchart of an example method for determining at least one of the following: (1) a likelihood of a new/unknown song becoming a hit song, and/or (2) a likelihood of a new/unknown performer becoming a hit song performer, and//or suggesting at least one of the following (1) suggestions of changes to the new/unknown song to increase the likelihood of the song becoming a hit song, (2) suggestions of changes to the new/unknown song to increase the likelihood of the performer becoming a hit song performer, and/or (3) suggestions of one or more alternative performers that are better suited to perform the song; and

FIG. 11 illustrates an example computing system in which the principles described herein may be employed.

### DETAILED DESCRIPTION

The principles described herein are related to a music analysis and recommendation engine (hereinafter also referred to as the “engine”) that is implemented at a computing system and configured to ingest, analyze, and classify the input data as assembled elements (including, but are not limited to, performer pictures, performer video, music audio, lyrics, contextual information, and/or other data) (1) to forecast if an unknown song could become a hit, (2) to qualify for assignment to potential performers, (3) to suggest possible adaptations or changes to increase the likelihood of a song to become a hit, either by the original author or alternative performer, (4) to suggest possible current and/or alternative music genre fittings, (5) to suggest potential consumer sectors, based upon cultural, social, and/or economic factors, and/or (6) to generate possible hits based upon structured knowledge base and artificial intelligence (AI) based generation, considering market and contextual information (also referred to as external contextual information).

The engine may operate in an automated manner without any human intervention during its analysis, classification, and suggestion processes. Alternatively, or in addition, human intervention may be introduced when exception events occur or at the final stage to eventually adjust and/or confirm the outcomes. The engine may be delivered as a SaaS or to be a part of a media eco-system to assist in the go-to-market music and performers production pipeline.

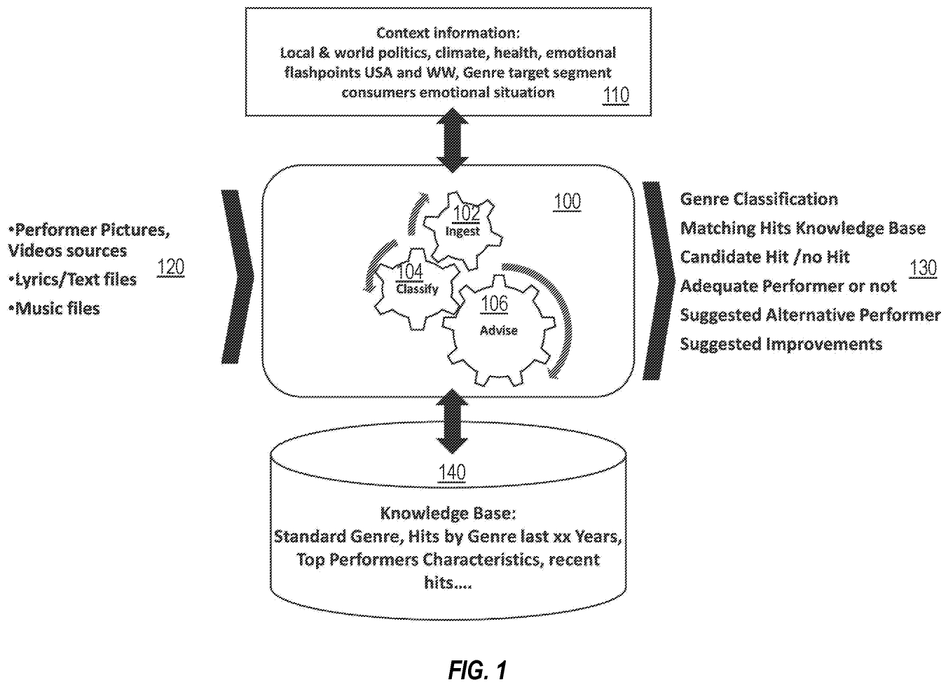

FIG. 1 illustrates a diagram of a general principle of the music analysis and recommendation engine 100 (also referred to as “the engine”). The engine 100 includes an ingest module 102, a classifying module 104, and an advising module 106. The engine 100 has access to contextual information 110, which may include a current contextual information repository and a historical contextual information repository. As used herein, the “current contextual information repository” includes current information related to a variety of topics including, but not limited to, local & world politics, climate, health, emotional flashpoints in the U.S. and/or worldwide, and/or genre target segment consumers emotional situation. As used herein, the “historical contextual information repository” includes historical information related to a variety of topics including, but not limited to, local & world politics, climate, health, emotional flashpoints in the U.S. and/or worldwide, and/or genre target segment consumers emotional situation. The engine 100 also has access to one or more knowledge bases 140, which may include knowledge bases of standard genres, hits by genre during a last several years (e.g., 50 years), top performers characteristics, and/or recent hits.

The engine 100 is configured to receive an input data 120 associated with a particular song (e.g., a new or unknown song), which may include performer pictures, performer videos, a lyrics (e.g., a text file), and/or music files (e.g., an audio file). Based upon the received input, the engine 100 ingests/analyzes the received input data 120 with the context information 110 and the knowledge base 140. Based upon the analysis, the engine 100 classifies the song associated with the input data 120 into one or more different classes (such as a particular genre) and/or determines (1) whether the song is likely to become a hit song, and/or (2) whether the performer is adequate. As used herein a “hit song” may comprise a song that exceeded a particular baseline of performance or success. For example, a hit song may comprise a song that sold over a certain number of copies. Additionally or alternatively, a hit song may comprise a song that charted above a certain number of a industry listing of song success.

Alternatively, or in addition, the engine 100 suggests an alternative performer and/or improvements that may be made to increase the likelihood of the song becoming a hit or the performer becoming a hit performer. In some embodiments, the engine 100 analyzes the audio of the song to determine a vocal range of melody of the song. The computing system then identifies one or more hit song performers in the same genre who have a vocal range that covers the vocal range of the melody of the song and suggests at least one of the identified one or more hit song performers as an alternative performer. The determinations and/or the suggestions can then be visualized as one or more outputs 130 to users.

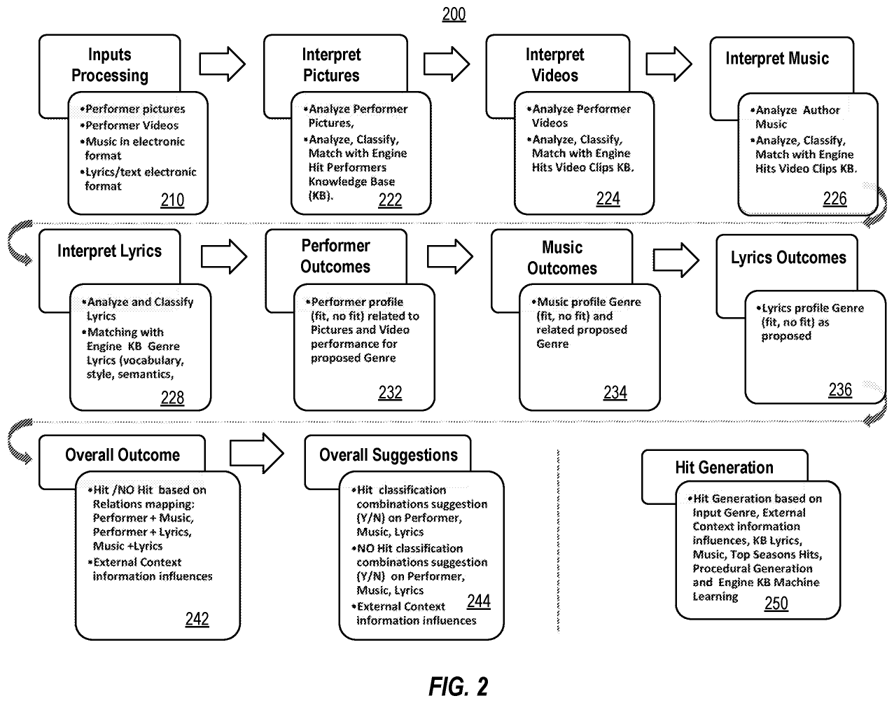

FIG. 2 illustrates a flowchart of an example process 200 that the engine 100 may perform. First, in act 210, the engine 100 receives inputs, containing performer pictures, performer videos, music in electronic format (e.g., mp3, .wav, .wma files), and/or lyric in electronic text format. Next, the engine 100 is configured to interpret each of the received performer pictures (act 222), the received performer videos (act 224), the received music (act 226), and/or lyrics (act 228).

The interpretation of the performer pictures (act 222) includes analyzing performer pictures to classify the performer pictures into a particular category (e.g., a genre), and matching the classified performer pictures with the performer pictures of hit song performers (contained in the knowledge base 140) that are within the particular category. The interpretation of the performer videos (act 224) includes analyzing the performer videos to classify the performer videos into a particular category, and matching the classified performer videos with performer videos of hit song performers (contained in the knowledge base 140) that are within the particular category. The interpretation of the music (act 226) includes analyzing the music audio file to classify the music into a particular category, and match the classified music with music audio files of hit songs (contained in the knowledge base 140). The interpretation of the lyrics (act 228) includes analyzing the lyrics to classify the lyrics into a particular category, and matching the classified lyrics with lyrics of hit songs (contained in the knowledge base 140) that are within the particular category.

The interpretation of the performer pictures (act 222) and the interpretation of the performer videos (act 224) related to the identified particular category of pictures and/or videos (e.g., genre) are recorded in a performer profile (act 232). In some embodiments, the interpretation of the music (act 226) may include a range of the melody, which may also be recorded as data associated with a vocal range of the performer in the performer profile. Additionally, the interpretation of the music (act 226) related to the identified particular category of music (e.g., genre) may be recorded in a music profile (act 234). Again, the interpretation of the lyrics (act 228) related to the identified particular category of lyrics (e.g., genre) may be recorded in a lyric profile (act 236).

Based upon the performer outcomes, music outcomes, and lyric outcomes generated in acts 232, 234, and 236, the engine 100 may then generate an overall outcome (act 242) and an overall suggestion (act 244). The overall outcome may include (but are not limited to) whether the song associated with the music data is likely to be a hit or not based upon relationships mapping between performer and music, performer and lyrics, and/or music and lyrics. The overall outcome may also include an indication of contextual information influences based upon the context information 110 of the current contextual information and historical contextual information. The overall suggestion(s) may include, but are not limited to, suggestions on performer, music, and/or lyric, based upon the hit outcome or no-hit outcome. The overall suggestion(s) may also be based upon contextual information influences.

Finally, in some embodiments, the engine is also configured to generate or suggest lyrics, portions of melodies, and/or performers of potential new hit songs based upon input genre, contextual information influences, the knowledge base containing lyrics, music, top seasons hits, procedural generation, and/or engine knowledge base machine learning (act 250).

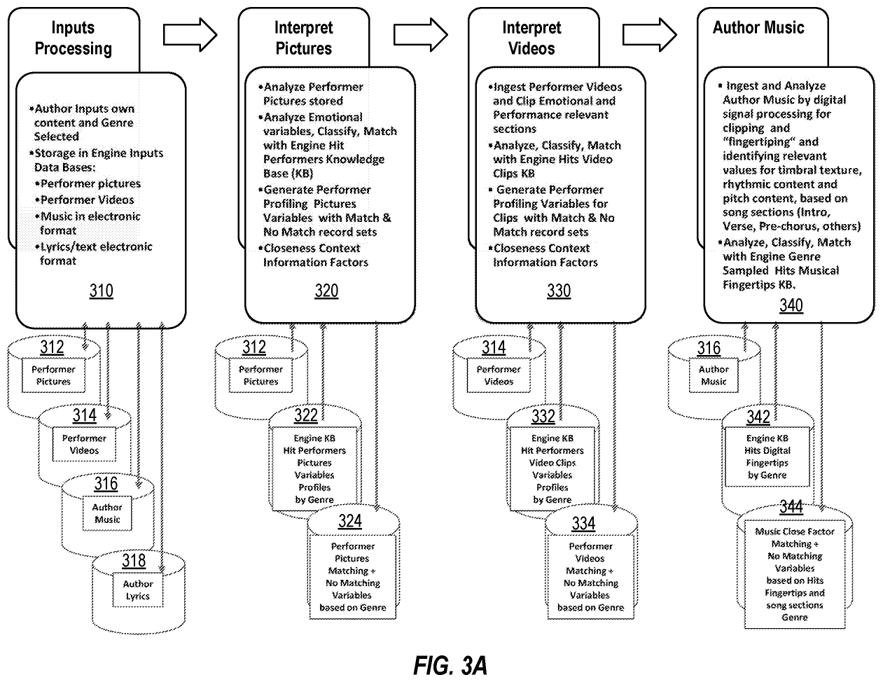

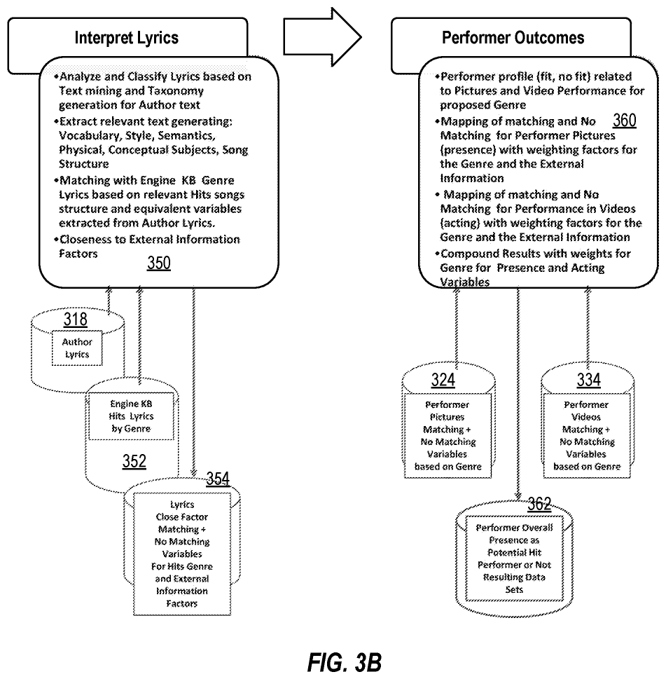

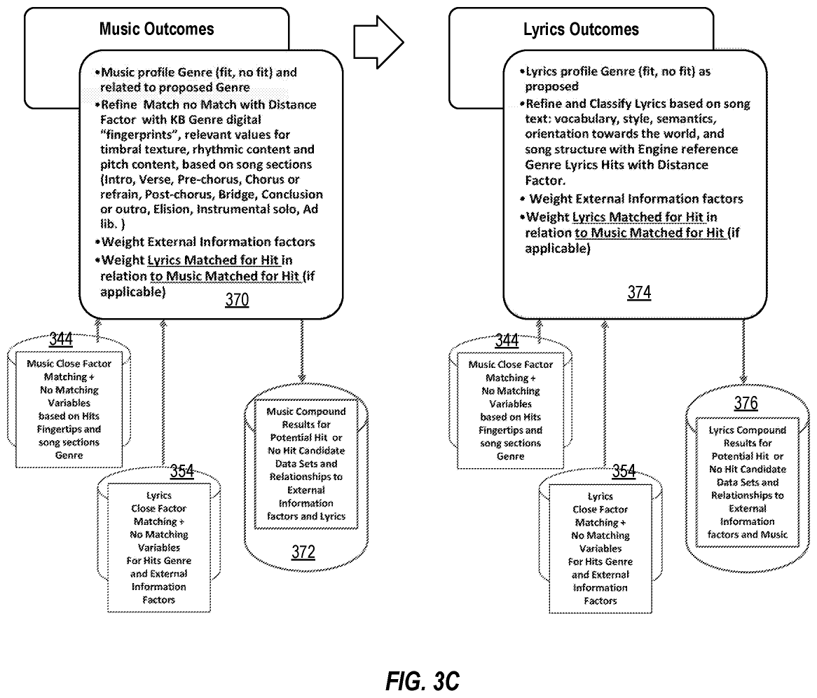

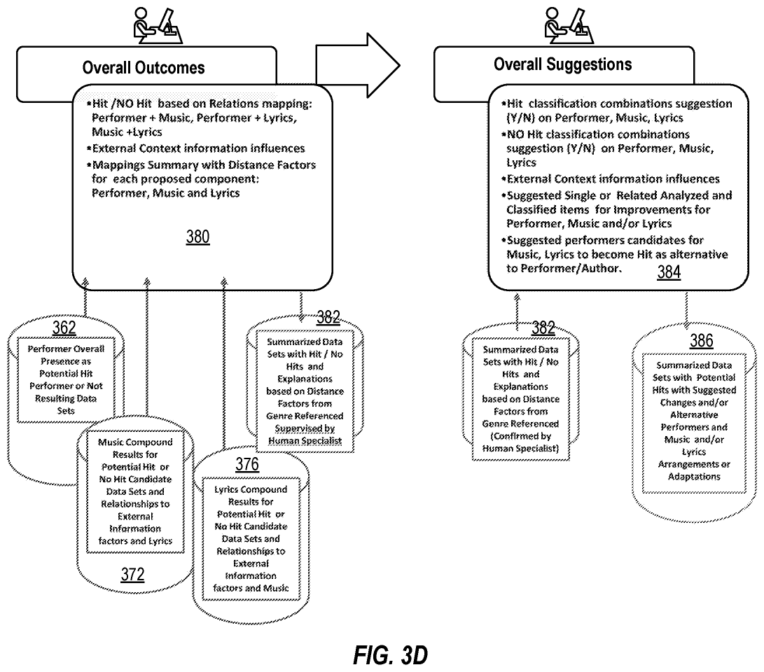

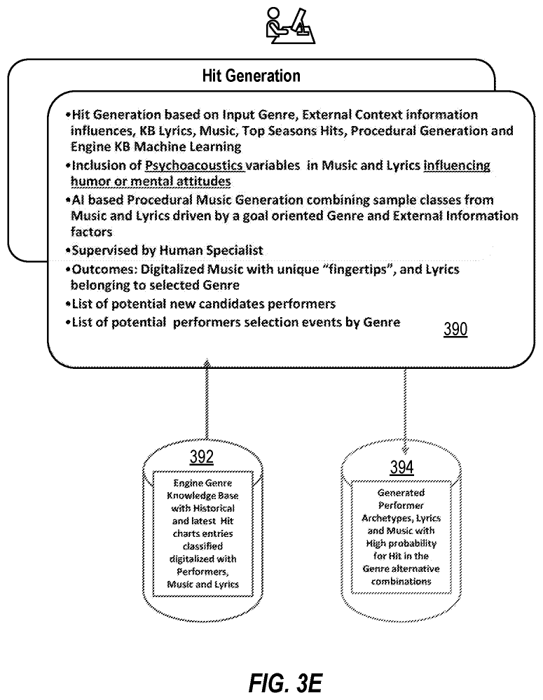

FIGS. 3A through 3E further break down the process 200 of FIG. 2 and provide additional details of each act illustrated in FIG. 2. FIG. 3A illustrates an act of inputting process 310, an act of interpreting pictures 320, an act of interpreting videos 330, and an act of interpreting music 340, which correspond to acts 210, 222, 224, and 226 of FIG. 2. In the act of inputting process 310, an author may input his/her own content, and selects a genre. Alternatively, the engine 100 may not be required to select a genre, because in some cases, the engine 100 is capable of determining a genre based on some of the author's input. The author's own content may include (but are not limited to) performer pictures 312, performer videos 314, music audio in electronic format 316 (e.g., an audio file), and lyric in electronic text format 318. The engine 100 may store the received content in one or more computer-readable storages coupled to the engine 100.

The act of interpreting pictures 320 includes ingesting and analyzing the performer pictures 312 stored in the one or more computer-readable storages. In particular, the analysis of the performer pictures may include (but are not limited to) identifying emotional variables of the performer, classifying the performer pictures into a particular category, and matching the input performer pictures with performer pictures of hit song performers (contained in the knowledge base 322, which corresponds to the knowledge base 140 of FIG. 1) that are within the particular category. Based upon the analysis, the engine 100 generates a performer picture profile 324 that records the one or more match or no-match record sets based upon the classified category (e.g., genre) and/or other variables associated with the performer picture.

The act of interpreting videos 330 includes ingesting and analyzing the performer videos 314 stored in the one or more computer-readable storages that are coupled to the engine 100. In particular, the analysis of the performer videos may include (but are not limited to) identifying emotional clip and performance in the performer videos, classifying the performer videos into a particular category, and matching the input performer videos with performer videos of hit song performers (contained in the knowledge base 332) that are within the particular category. Based upon the analysis, the engine 100 generates a performer video profile 334 that records the one or more match or no-match record sets based upon the classified category (e.g., genre) and or additional variables related to the performer videos.

The act of interpreting music 340 includes ingesting and analyzing the music 316 (also referred to as author music) stored in the one or more computer-readable storages. In particular, the analysis of the author music 316 includes using digital signal processing (DSP) to transform the audio data into a frequency spectrum over time, and generating a frequency “fingerprint” of the music. Based upon the frequency data and/or the frequency “fingerprint” of the music, the engine 100 is configured to identify timbral texture, rhythmic content, and pitch content of the music based upon song sections (e.g., intro, verse, pre-chorus, etc.). Based upon the analysis, the engine 100 classifies the music into a particular category, matches the music audio with hit song audio (contained in knowledge base 342) that are within the particular category, and generates a music profile 344 that records the “fingerprint,” the match/no-match record sets based upon the classified category (e.g., genre), and/or other variables associated with the audio of the song.

FIG. 3B illustrates an act of interpreting lyrics 350 and an act of generating performer outcomes 360, which correspond to the acts 228 and 232 of FIG. 2. The act of interpreting lyrics includes accessing and analyzing the lyrics 318 (also referred to as author lyrics) stored in the one or more computer-readable storages. The analysis of the lyrics 318 may include, but are not limited to, extracting relevant text features based upon text mining and taxonomy generation. The features may include, but are not limited to, vocabularies, styles, semantics, physical and/or conceptual subjects, and/or song structures. Based upon the analysis, the engine 100 classifies the lyrics into a particular category, matches the extracted text features with text features of relevant hit songs (contained in the knowledge base 352) that are within the particular category, and generates a lyric profile 354 that records lyric variables, such as match/no-match record sets based upon the classified category (e.g., genre) and contextual information factors 110.

The act of generating performer outcomes 360 includes accessing a performer picture profile 324 and the performer video profile 334 generated in acts 320 and 330. Based upon the performer picture profile 324 and the performer video profile 334, the engine 100 weights the match/no-match record sets contained in the profiles 324 and 334 to generate a compound result 362, which indicates the performer's overall presence and a likelihood of the performer becoming a hit song performer.

FIG. 3C illustrates an act of generating music outcomes 370 and an act of generating lyric outcomes 374, which correspond to the acts 234 and 236 of FIG. 2. The act of generating music outcomes 370 includes accessing the music profile 344 and the lyric profile 354 generated in acts 340 and 350 of FIGS. 3A and 3B. At the same time, the engine 100 also accesses the contextual information 110. Based upon the music profile 344 and lyric profile 354, the engine 100 generates weights to weight the match/no-match record sets contained in the profile 344 and 354. Further, based upon the context information 110, the engine 100 also considers the external information factors in addition to the weighted match/no-match record sets to generate a compound result 372, indicating an overall likelihood of the music becoming a hit or not.

The act of generating lyric outcomes 374 also includes accessing the music profile 344 and the lyric profile 354 generated in acts 340 and 350 of FIGS. 3A and 3B. The engine 100 also accesses the contextual information 110. Based upon the music profile 344 and lyric profile 354, the engine 100 generates weights to weight the match/no-match record sets contained in the profile 344 and 354. Further, based upon the contextual information 110, the engine 100 also considers the external information factors in addition to the weighted match/no-match record sets to generate a compound result 376, which indicates the likelihood of the lyrics becoming a hit or not.

Note, in acts 370 and 374, same or similar sets of data are used to generate different results, one is the likelihood of whether the music becomes a hit, and the other is the likelihood of whether the lyrics becomes a hit. In some embodiments, the different results may be generated based on giving a different weight to the music profile 344, the lyric profile 354, and/or the relationship between the lyrics and the external contextual information.

FIG. 3D illustrates an act of generating overall outcome 380 and an act of generating overall suggestion(s) 384, which correspond to acts 242 and 244 of FIG. 2. The act of generating overall outcome 380 includes accessing and analyzing the performer compound/overall result(s) 362, the music compound result(s) 372, and the lyric compound result(s) generated in acts 360, 370, and 374. At the same time, the engine 100 also has access to the contextual information 110. Based upon the compound results 362, 372, and 374, and the contextual information 110, the engine 100 generates a summary 382, summarizing hit/no-hit determinations, and explaining based upon distance factors from referenced category or genre. This process may be performed automatically by a computing system of the engine 100 or further supervised by a human specialist. For example, the human specialist may manually confirm or reject each result or at least some of the results in the summary.

The act of generating overall suggestions 384 includes accessing and analyzing the summary 382 generated in act 380. Based upon the summary 382 and the external contextual information influences, the engine 100 generates one or more suggestions 386 for improvements for the performer, music and/or lyrics. The engine 100 may also suggest one or more alternative performer candidates 386 who are more suited for the song. In some embodiments, the engine analyzes the audio of the song to determine a vocal range of melody of the song. The computing system then identifies one or more alternative song performers in the same genre who have a vocal range that covers the vocal range of the melody of the song and suggests at least one of the identified one or more alternative song performers as an alternative performer.

FIG. 3E illustrates an act of generating a hit (390), which corresponds to the act 250 of FIG. 2. The act of generating a hit 390 includes accessing an engine genre knowledge base 392 with historical and latest hit charts entries classified and digitalized with performers (e.g., performer pictures and/or performer videos), music, and lyrics. In some embodiments, psychoacoustics variables in music and lyrics influencing humor or mental attitudes are also taken into account. The engine 100 receives a user input of genre. The engine 100 includes an artificial intelligence (AI) based procedural music generator that combines sample classes from music and lyrics driven by a goal-oriented genre and external contextual information factors to generate suggestions 394 including performer archetypes, lyrics, and music with high probability for hit in the genre and with alternative combinations from the existing hit songs.

Different machine learning technologies may be implemented to classify and identify match/no-match among images (e.g., performer pictures), sequences of images (e.g., performer videos), audios (e.g., songs), and/or text (e.g., lyrics and contextual information).

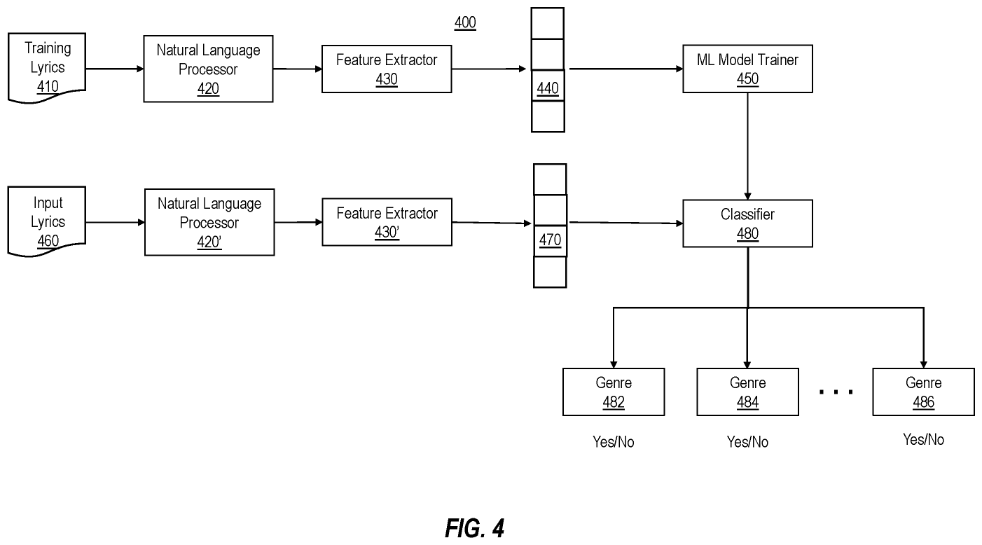

FIG. 4 illustrates an example embodiment of using natural language processing 400 to implement a supervised machine learning process to generate a lyrics classifier model for classifying lyrics into a plurality of genres 482, 484, and 486. As illustrated in FIG. 4, training lyrics 410 are used to train a classifier model 480. The training lyrics 410 include the lyrics of multiple songs that have been previously classified manually to one of a plurality of genres or categories. The training lyrics 410 are fed into a natural language processor 420. The natural language processor 420 may tag certain words contained in the lyrics and/or convert at least some of the words to stems of the words. The processed lyrics text is then sent to a feature extractor 430 to convert the lyrics text of each song into a text vector 440, each of which corresponds to a category or genre. These text vector and genre duples are then fed into a machine learning model trainer 450 to build a lyrics classifier 480 (also referred to as a classifier model 480 or a machine learning classifier model 480), which is configured to classify or predict a genre of a new or unknown song based on the lyrics of the new/unknown song.

For example, as illustrated in FIG. 4, a new song's lyrics 460 are first processed by a natural language processor 420′ and a feature extractor 430′ to generate a text vector 470 representing the new song's lyrics 460. Next, the text vector 470 is fed to the classifier 480, and the classifier 480 determines which genre 482, 484, or 486 that the new song belongs to.

Note, in some embodiments, the natural language processor 420′ and the feature extractor 430′ may correspond to the natural language processor 420 and the feature extractor 430 that are used to generate the classifier 480. In some embodiments, the natural language processor 420′ and the feature extractor 430′ are separate modules from the natural language processor 420 and the feature extractor 430.

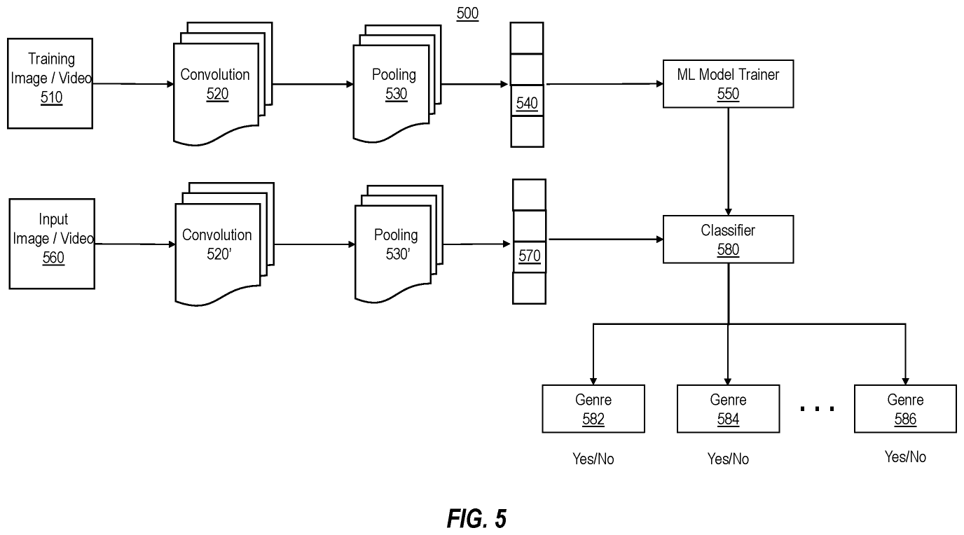

FIG. 5 illustrates an example embodiment of using a convolutional network 500 to implement a supervised machine learning process to generate an image classifier model 570 for classifying performer images and/or videos into a plurality of genres or categories 582, 584, and 586. The genres 582, 584, and 586 may or may not correspond to the genres or categories of 482, 484, and 486. As illustrated in FIG. 5, training images and/or training videos 510 are used to train the classifier 580. The training images and/or training videos 510 include images and/or videos of multiple performers, which have been previously classified into one of a plurality of categories or genres 582, 584, and 586.

The training images and/or videos 510 are fed into a convolution layer or processor 520, which includes one or more filters filtering the input images 510 (and/or a sequence of images in the input video). Each of the one or more filters is convolved across a width and height of the input image 510 (and/or a sequence of images in the input video). The filtered images by the convolution layer 520 are then processed by a pooling layer or processor 530, which is a form of down-sampling. The down-sampled images are represented as a set of feature vectors 540, each of which corresponds to a category or genre. The feature vectors 540 and the genre duples are then sent to a machine learning model trainer 550 to build a classifier model 580, which is configured to determine which genre or category a performer belongs to based on the performer's image and video.

For example, as illustrated in FIG. 5, a picture or video of a new performer 560 is first processed by a convolution processor 520′ and a pooling processor 530′ to generate an image vector 570 representing the image of the new performer 560. Next, the image vector 570 is fed into the classifier 580, and the classifier 580 determines which genre 582, 584, or 586 the performer belongs to.

Note, a video is a sequence of images, each of which may be processed individually by the convolutional network 500. Alternatively, or in addition, a sequence of images may further be processed to identify one or more movement patterns of the performer and/or emotion patterns of the performer. The movement patterns and/or the emotion patterns the performer may be identified based upon the motion of body parts, hand gestures, and/or facial expressions. These movement patterns and/or the emotion patterns may further be classified into different categories or genres.

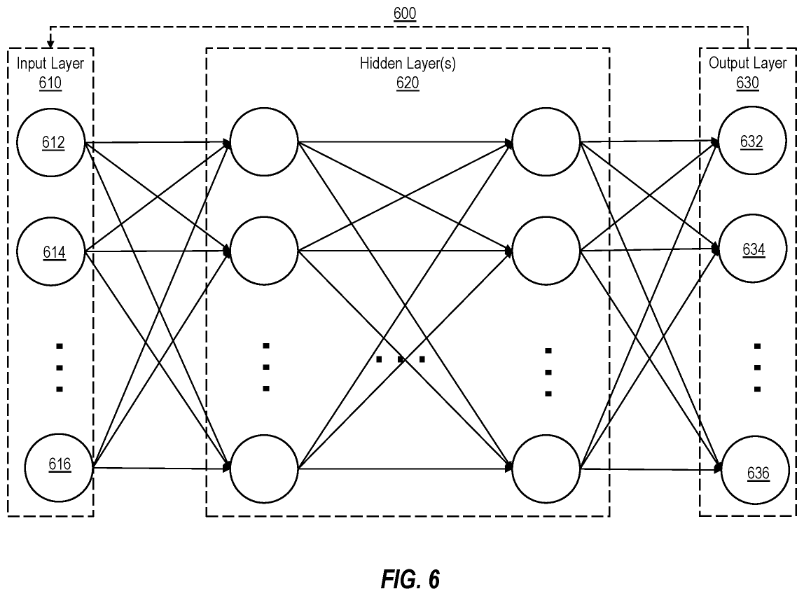

Different training algorithms may be implemented in the model trainer 450 or 550 to train the classifier model 480 or 580. In some embodiments, an artificial neural network may be implemented to train the classifier model 480 or 580. FIG. 6 illustrates an example artificial neural network (ANN) 600, which may be used in the machine learning model trainer 450 or 550. The ANN 600 includes an input layer 610, which is configured to receive the text vectors 540 or the image vectors 570. Each dimension value of the text vectors 540 or image vectors 570 is input in one of the neurons 612, 614, or 616. The ANN 600 also includes one or more hidden layers 620. Each of the hidden layers 620 also includes one or more neurons. The number of hidden layers and the number of neurons in each layer may be determined manually or by various optimization algorithms. The ANN 600 also includes an output layer 630. Each neuron 632, 634, or 636 of the output layer is associated with a category or genre corresponding to the genres 482, 484, 486, or 582, 584, or 586.

In some embodiments, the output of certain neurons in the output layer and/or a hidden layer may also be sent back to the input layer and/or other hidden layers to achieve a specific training goal. For example, when a sequence of image vectors representing a video is input in the input layer 610, the output of the previous image vector may be sent back to the input layer 610 to have the ANN 600 to further learn the sequential patterns among the sequence of the images.

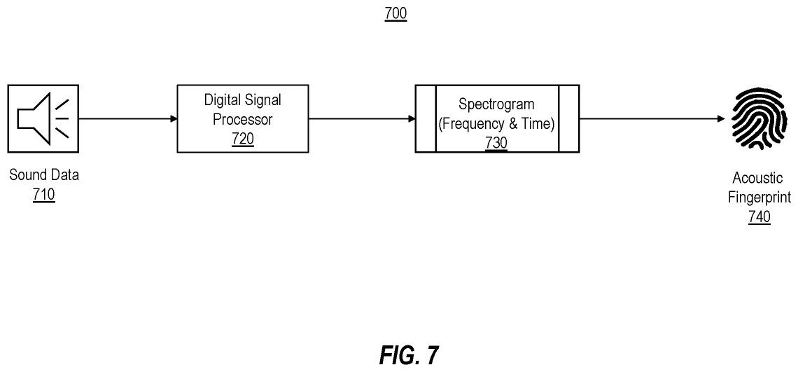

Furthermore, audio files or sound data of the songs can also be pre-processed and classified into multiple classes. FIG. 7 illustrates an example embodiment 700 of pre-processing audio data of songs 710. In embodiments, the sound data 710 is processed by a digital signal processor 720 to generate a spectrogram 730. A spectrogram 730 is a visual representation of the spectrum of frequencies of the sound signal. Since the sound signal is a continuous signal over a period of time, the spectrogram 730 may include frequency in one dimension and a time in another dimension, and the different song volumes in different frequencies at different times may be represented by different colors. In some embodiments, the spectrogram may be further processed (e.g., split, cropped, down sampled, filtered, etc.) to generate an acoustic fingerprint 740 for the song. In some embodiments, the whole spectrogram may be used as the fingerprint 740 of the song. The spectrogram may also be divided into sections, including (but are not limited to) intro, verse, pre-chorus. A particular section of the spectrogram of the song may be used as the fingerprint 740 of the song. In some embodiments, since the spectrogram 730 is an image, the spectrogram 730 may further be processed via a convolutional network (e.g., convolutional network 500 of FIG. 5) to train a machine learning audio classifier model configured to determine a genre or category of a song based on the audio data of the song.

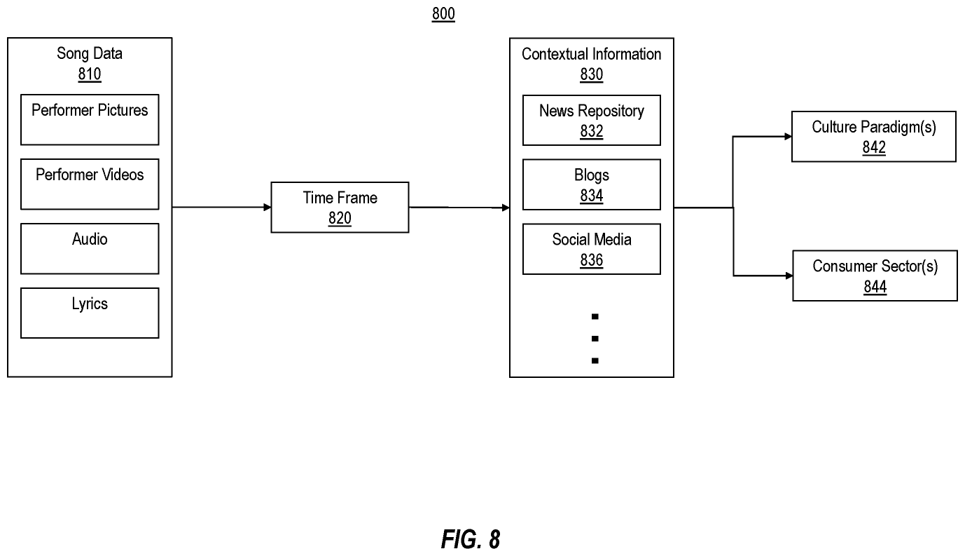

In embodiments, the data associated with songs may also be mapped to a cultural paradigm and/or a consumer sector. FIG. 8 illustrates an example embodiment 800 of mapping a song 810 (including previous hits, current hits, and/or a new song) to one of a plurality of cultural paradigms 842 and/or one of a plurality of consumer sectors 844. For example, cultural paradigms may include (but are not limited to) a civil rights movement, a Black Lives Matter movement, an LGBTQ movement, a feminist movement, and/or an anti-war movement. As another example, consumer sectors may include (but are not limited to) a teenager group, a black listener group, generation Z, millennials, generation X, and/or baby boomers.

For each of the hit songs, the engine 100 determines a time frame 820 during which the hit song became a hit. Based on the determined time frame 820, the engine 100 accesses contextual information 830 (also described as contextual information 110 in FIG. 1) to extract historical contextual information associated with the time frame 820. The contextual information 830 may be obtained from various public or private repositories, including, but are not limited to, news repositories 832, blogs 834, and/or social media 836. The contextual information 830 may be analyzed via a natural language processor to identify keywords and key events of the time frame to identify a cultural paradigm 842 corresponding to the keywords and key events. Further, the contextual information 830 may also be processed to identify the fan group or consumer sector 844 of the corresponding hit song, including (but are not limited to) the age group, economic group, and/or racial group. For each new song, the engine 100 may assume the time frame 820 is current. Based on the current time, the engine 100 accesses current contextual information 830, which includes, but is not limited to, current news, current social media, and/or current blog posts, to determine a current paradigm.

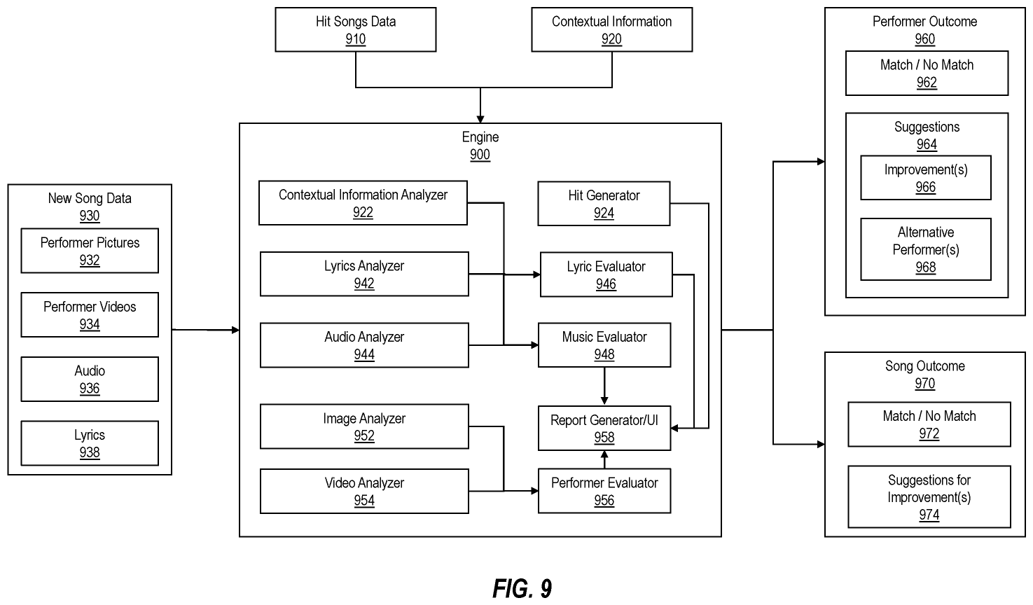

FIG. 9 illustrates an example architecture of the music analysis and recommendation engine 900, which corresponds to the engine 100 of FIG. 1. The engine 900 has access to one or more repositories of data associated with hit songs 910 and one or more repositories of data associated with contextual information 920 (which corresponds to the contextual information 110 of FIG. 1). The data associated with hit songs 910 includes performer pictures, performer videos, lyrics, and/or audio files of the hit songs. The contextual information 920 corresponds to the contextual information 110 of FIG. 1 and/or 830 of FIG. 8, including (but are not limited to) news repositories, social media, and/or blogs.

A user can input or upload data associated with a new song 930 into the engine 900. The data associated with the new song 930 may include, but is not limited to, (1) one or more performer pictures 932, (2) one or more performer videos 934, (3) a music audio file of the song 936, and/or (4) lyrics of the song 938. The engine 900 includes a contextual information analyzer 922 configured to retrieve and analyze the contextual information 920 of the current time to determine a current cultural paradigm and to identify one or more historical periods that have a cultural paradigm matching the current cultural paradigm.

The engine 900 also includes a lyrics analyzer 942, which may implement the machine learning classifier model 480 of FIG. 4. The lyrics analyzer 942 is configured to analyze and classify the lyrics of the new song 938 into a particular category or genre and find one or more hit songs that belong to the particular category or genre and/or become hit songs during the identified one or more historical periods. The lyrics analyzer 942 is also configured to determine a similarity between the lyrics of the new song 938 and the lyrics of the one or more retrieved hit songs, which may be represented as match or no-match binary results, or as numeric similarity scores. Based upon the determined similarities between the lyrics of the new song 938 and those of the hit songs, the lyrics analyzer 942 may then determine a likelihood (also referred to as a first likelihood) of the lyrics of the song becoming hit song lyrics.

The engine 900 also includes an audio analyzer 944, which may implement the digital signal processor 720 of FIG. 7 to transform the audio data into a spectrogram 730 before further analysis. The audio analyzer 944 is configured to analyze and classify the audio file of the new song 936 into a particular category or genre and find one or more hit songs that belong to the particular category or genre and/or become hit songs during the identified one or more historical periods. The audio analyzer 944 also determines a similarity between the audio of the new song 936 and the audio files of the one or more retrieved hit songs, which may be represented as match or no-match binary results, or as numeric similarity scores. Based on the determined similarities between the audio file of the new song 938 and those of the hit songs, the audio analyzer 944 may also determine a likelihood (also referred to as a second likelihood) of the music of the song becoming a hit song music.

The engine 900 also includes a song evaluator 946, which is configured to assign a weight to each of the first likelihood and the second likelihood of the song becoming a hit song determined by the lyrics analyzer 942 and the audio analyzer 944 and weight the first likelihood and the second likelihood of the song to generate an overall or compound likelihood of the lyrics of the song becoming hit song lyrics. In some embodiments, the song evaluator 946 also determines a relatedness between the lyrics of the song 938 and the current cultural paradigm to generate an external information factor. The external information factor may also be assigned a weight and weighted with the first likelihood and the second likelihood of the song to generate the overall or compound result.

The engine 900 also includes a music evaluator 948, which is similar to the lyric evaluator 946. The music evaluator 948 also assigns a weight to each of the first likelihood and a second likelihood and weight the first likelihood, the second likelihood, and/or the relatedness between the lyrics of the song 938 and the current cultural paradigm to generate an overall likelihood of the music of the song becoming hit song music. Note, the weights assigned by the lyric evaluator 946 and the weights assigned by the music evaluator 948 may be different. Thus, the overall likelihood of the lyrics of the song becoming hit song lyrics and the overall likelihood of the music of the song becoming hit song music may be different.

The engine 900 also includes an image analyzer 952, which may implement the classifier model 580 of FIG. 5. The image analyzer 952 is configured to analyze the performer picture of the new song 932 and classify the performer picture 932 into a particular category or genre and find one or more hit songs that belong to the particular category or genre and/or become hit songs during the identified one or more historical periods. The image analyzer 952 is also configured to determine a similarity between the performer picture 932 of the new song and performer pictures of the one or more retrieved hit songs, which may be presented as match or no-match binary results, or as numeric similarity scores. Based on the determined similarities between the performer pictures of the new song 932 and those of the hit songs, the image analyzer 952 may then determine a likelihood (also referred to as a first likelihood) of the performer becoming a hit song performer.

The engine 900 also includes a video analyzer 954, which may implement the classifier model 580 of FIG. 5 and/or additional machine learning models that are trained to identify and classify movement patterns and/or facial expressions of performers. The video analyzer 954 is configured to analyze and classify the video file of the new song 934 into a particular category or genre and find one or more hit songs that belong to the particular category or genre and/or become hit songs during the identified one or more historical periods. The video analyzer 954 also determines a similarity between the performer video of the new song 934 and those of the hit songs, which may be represented as match or no-match binary results, or as numeric similarity scores. Based on the determined similarities between the video file of the new song 934 and those of the hit songs, the video analyzer 954 may also determine a likelihood (also referred to as a second likelihood) of the performer becoming a hit song performer.

The engine 900 also includes a performer evaluator 956, which is configured to assign a weight to each of the first likelihood and the second likelihood of the performer becoming a hit song performer determined by the image analyzer 952 and the video analyzer 954 and weight the first likelihood and the second likelihood of the performer to generate an overall or compound likelihood of the performer becoming a hit. In some embodiments, the contextual information analyzer 922 also identifies a consumer sector of the song based on the determined category or genre of the song. The performer evaluator 956 also determines a relatedness between the performer pictures/videos and the identified consumer sector of the song to generate an external information factor. The external information factor may also be assigned a weight and weighted with the first likelihood and the second likelihood of the performer to generate the overall or compound result.

Finally, the engine 900 may also include a report generator and/or a user interface 958 that is configured to generate a performer outcome 960 and/or a song outcome 970 based on the overall results generated by the lyric evaluator 946, music evaluator 948, and the performer evaluator 956. The performer outcome 960 may include a match/no match report 962, listing one or more hit song performers that match the performer of the new song. The match/no match report 962 may also show a similarity or matching score indicating the level of match between the performer of the new song and the hit song performers. The performer outcome 960 may also include suggestions 964 related to the performer of the new song. The suggestions 964 may suggest one or more possible improvements 966 based on the factor(s) that are less similar between the performer of the new song and the hit song performers, such that the performer may improve his/her likelihood of becoming a hit song performer. Alternatively, or in addition, the suggestion 964 may also suggest one or more alternative performers 968 who may be better suited to perform the new song 930 than the original performer. In some embodiments, the audio of the song is analyzed to determine a range of melody of the song. The computing system then identifies one or more hit song performers in the same genre who have a vocal range that covers the vocal range of the melody of the song and suggests at least one of the identified one or more hit song performers as an alternative performer.

The song output 970 may also include a match/no match report 972, listing one or more hit songs that match the lyrics and/or music of the new song. The match/no match report 972 may also show a similarity or matching score indicating the level of match between the new song and the hit songs. The song outcome 970 may also include suggestions 974 related to the new song. The suggestions 974 may suggest one or more possible improvements 966 of the lyrics, the melody, and/or the adaptations of the song based on factor(s) that are less similar between the new song and the hit songs, such that the song is more likely to become a hit song.

In some embodiments, the report generator 958 also generates a user interface that allows users to interact with the generated overall outcome. For example, a user may review the manually confirm or reject the overall results in the match/no match report 972 when a match or no-match result is correct or incorrect. The user may also review the generated suggestions to manually confirm or reject each one or some of the suggestions.

As an example, the engine 900 is provided as a SaaS platform that presents a user interface for users to input their data. The users may be a performer, a songwriter, an agent, an advertising agency, and/or a potential investor to a production of a song. The data may include (but are not limited to) a performer's profile picture 932 (e.g., a .jpeg file), a music video 934 of the performer performing the song (e.g., an .mp4 file), an audio file 936 of the performer performing the song (e.g., an .mp3 file), and lyrics 938 of the song (e.g., a .txt file).

Once the engine 900 receives the user's profile picture, video, audio, and lyrics, the engine 900 first analyzes each of the files separately. For example, the profile picture is analyzed using the image analyzer 952 (which may include a first ML model built using a first ML network); the video is analyzed using the video analyzer 954 (which may include a second ML model built using a second ML network); the audio file is transformed into a spectrogram and analyzed using the audio analyzer 944 (which includes a third ML model built via a third ML network); and the lyrics file is analyzed by the lyrics analyzer 942 (which includes a NLP model built using a fourth ML network).

Based on the analysis of the profile picture, the image analyzer 952 may determine that the performer fits into the category of pop song singer. In many cases, the video analyzer 954 would determine that the video fits into the same category as that determined by the image analyzer 952. However, in some cases, the two determinations may not match. For example, based on the analysis of the video, the video analyzer 954 may determine that the video fits into the category of rock and roll. In such a case, the performer evaluator 956 may assign a first weight to the determination of the image analyzer 952 and a second weight to the determination of the video analyzer 954 and weight the two determinations to generate an overall determination of whether the performer is a pop singer or a rock and roll singer. The weights may be assigned based on a confidence level of each determination.

Assuming that the overall determination of the performer is a pop song singer, the performer evaluator 956 may then identify a plurality of hit pop song performers and retrieve data associated with these identified hit pop song performers 910, including their profile pictures and music videos. The performer evaluator 956 may then compare the user's performer picture/video with the hit pop song performers' profile pictures/videos to determine a similarity or dissimilarity. Based on the determined similarity or dissimilarity of the performer pictures, the performer evaluator 956 may predict a first likelihood of whether the performer becomes a hit song performer. Based on the determined similarity or dissimilarity of the videos, the performer evaluator 956 may predict a second likelihood of whether the performer becomes a hit song performer. The first likelihood and the second likelihood may also be assigned different weights and be weighted to determine an overall likelihood of the performer becoming a hit song performer. Further, the performer evaluator 956 may also suggest changes to the performer, e.g., wearing brighter color, wearing a hat, happier facial expression, additional dance moves, to increase the likelihood of the performer to become a hit song performer.

Similarly, based on the analysis of the audio file, the audio analyzer 944 may determine that the melody or adaptation of the song fits into the category of pop song. Again, based on the analysis of the lyrics file, the lyrics analyzer 942 may determine that the lyrics of the song also fits into the category of pop song. The engine 900 then identifies one or more recent hit pop songs and retrieves audio files and lyrics files of these identified recent hit pop songs. The engine 900 may then compare the user's audio/lyrics file with the audio/lyrics files of the identified hit pop songs to determine a similarity or dissimilarity. Based on the determined similarity or dissimilarity of the audio files, the music evaluator may determine a likelihood of the music to become a hit song music and/or the likelihood of the lyrics to become hit song lyrics.

The engine 900 then identifies one or more recent hit pop songs and retrieves audio files and lyrics files of these identified recent hit pop songs. The engine 900 may then compare the user's audio file with the audio files of the identified hit pop songs to determine a similarity or dissimilarity. Based on the determined similarity or dissimilarity of the audio files, the music evaluator may determine a likelihood of the music to become a hit song music. In some embodiments, based on the determined similarity or dissimilarity of the audio files/lyrics, the music evaluator may determine a likelihood of the music to become a hit song music. Based on the determined similarity or dissimilarity of the audio files/lyrics, the lyrics evaluator may determine a likelihood of the lyrics to become a hit song lyrics. Further, the engine 900 may also suggest changes to the melody, adaptation and/or lyrics of the user's song. In some embodiments, the engine 900 may identify one or more hit pop songs that are the most similar to the user's songs, and the suggestions are provided based on the identified most similar hit pop songs.

In many cases, the determinations of lyrics analyzer 942 and the audio analyzer 944 match. However, in some cases, the two determinations may not match. For example, based on the analysis of the lyrics, the lyrics analyzer 942 may determine that the lyrics fits into the category of country song; and based on the analysis of the audio file, the audio analyzer 944 may determine that the music fits into the category of pop song. In such a case, the lyric evaluator 946 or the music evaluator 948 may suggest changes to the lyrics or the music to cause the lyrics and the music fit more into a same category. For example, the lyrics evaluator 946 may suggest words that may be considered to be added or removed from the lyrics to make the lyrics fit into the category of the music (e.g., pop song). Alternatively, the music evaluator 948 may suggest different adaptations or different melodies modifying the music to fit into the category of the lyrics (e.g., country song).

Further, the engine 900 also includes the contextual information analyzer 922 that has access to current and historical contextual information 920, such as news repositories, social media, blogs. Based on the current contextual information, the contextual information analyzer 922 can identify a current cultural paradigm. For example, the contextual information analyzer 922 may determine that the current cultural paradigm includes the Black Lives Matter movement. Based on the determined cultural paradigm, the contextual information analyzer 922 may also identify a plurality of words that are associated with the current cultural paradigm. The lyrics evaluator 946 may also compare the lyrics with the plurality of words associated with the current cultural paradigm to determine whether the lyrics of the song are related to the current cultural paradigm. Based on the relatedness between the lyrics and the current cultural paradigm, the engine 900 may assign a relatedness indicator to the lyrics of the song. The relatedness indicator is used to further adjust the likelihood of the lyrics becoming a hit song lyrics. For example, when the relatedness indicator indicates a strong relationship between the lyrics of the song and the current cultural paradigm, the engine 900 increases the likelihood of the lyrics becoming a hit song lyrics based on the relatedness indicator.

In some embodiments, the audio analyzer 944 also analyzes the audio file of the user's song to determine a vocal range of melody of the song. When the performer evaluator 956 determines that the similarity between the performer and hit song performers is low, the performer evaluator 956 may recommend one or more alternative performers. In some embodiments, the performer evaluator 956 may identify one or more hit song performers that belong to the same category (e.g., hit pop song performers) and have vocal ranges that cover the vocal range of the melody of the user's song, and the suggest at least one of the identified song performers as alternative performer(s).

The determinations and suggestions of the performer evaluator 956, lyrics evaluator 946, and music evaluator 948 are then sent to the report generator 958, which in turn generates and presents to the user a performer outcome report 960 and a song outcome report 970. When a user reviews the performer outcome report 960 and the song outcome report 970, the user may interact with the reports 960 and/or 970 and provide additional feedback. For example, the performer outcome report 960 may include a match/no-match report 962, which may present a list of hit song singers that matches to the performer. The user may confirm or reject each of the matched or not matched hit song performers. The user may also accept or reject each of the suggestions. In response to receiving the user feedback, the report generator 958 updates the report to reflect the user's feedback. In some embodiments, the report generator 958 may also send user's feedback back to the evaluators 946, 948, 956 and/or the analyzers 942, 944, 952, 954. The evaluators 946, 948 956 and/or the analyzers 942, 944, 952, 954 may “learn” from the user's feedback and modify their ML models. Such that when a next user's song data is received, the engine 900 analyzes the new song data based on the modified ML models.

Additionally, in some embodiments, the engine 900 also includes a hit generator 924. The hit generator 924 is configured to receive a user input of a genre. Based on the input genre, the contextual information 920 of the current time, and top seasonal hit songs (contained in the hit song data 910), the hit generator 924 is configured to generate a list of potential new candidate performers. The hit generator 924 is further configured to generate a list of words that may be used in lyrics of a new song, and/or melody of the new song, which are related to the current hit songs that belong to the input genre, yet unique and different from the current hit songs.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

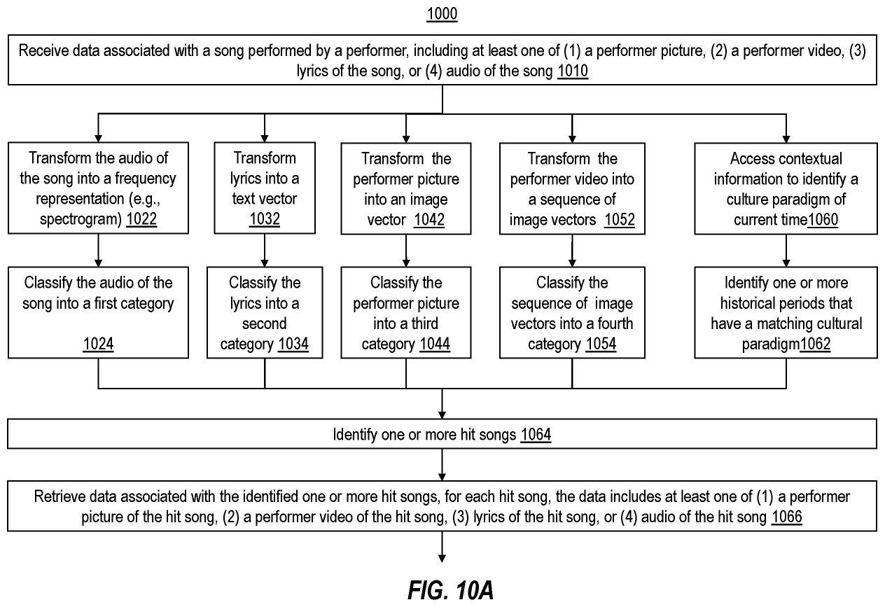

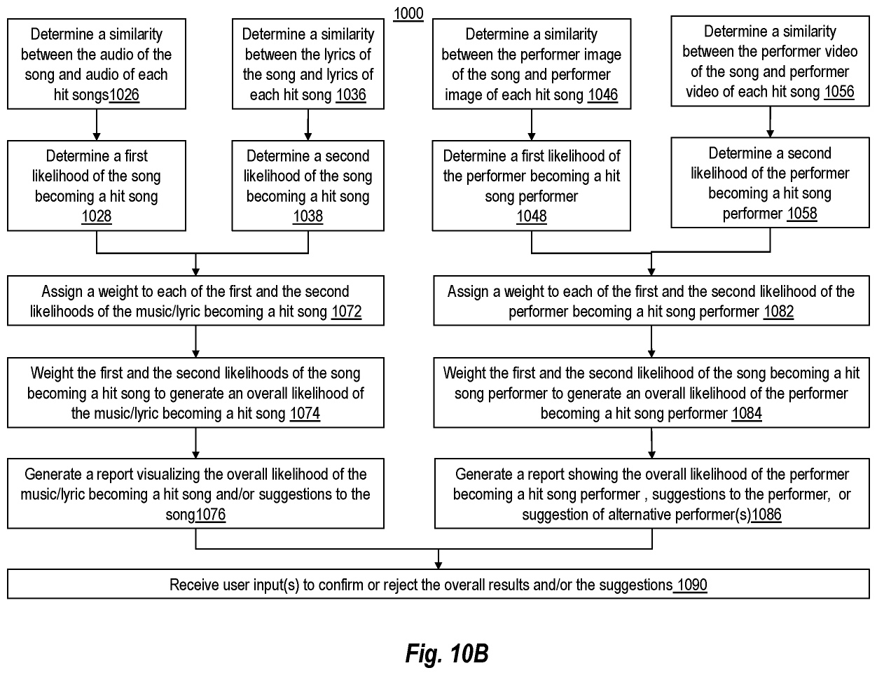

FIGS. 10A and 10B illustrate a continuous flowchart of an example method 1000 for determining at least one of the following: (1) a likelihood of a new/unknown song becoming a hit song, and/or (2) a likelihood of a new/unknown performer becoming a hit song performer, and/or providing at least one of the following: (1) suggestions of changes to the new/unknown song to increase the likelihood of the song becoming a hit song, (2) suggestions of changes to the new/unknown song to increase the likelihood of the performer becoming a hit song performer, and/or (3) suggestions of one or more alternative performers that are better suited to perform the song.

The method 1000 includes receiving data associated with a song (e.g., a new song) performed by a performer (e.g., a new performer) (act 1010). The data includes at least one of (1) a performer picture of the performer, (2) a performer video of the performer, (3) lyrics of the song, or (4) music audio of the song. The method 1000 also includes transforming the audio of the song into a frequency representation (e.g., a spectrogram) (act 1022) (which may be performed by the digital signal processor 720 of FIG. 7) and classifying the audio of the song into a particular category (i.e., a first category) of a plurality of categories (act 1024). The method 1000 also includes transforming lyrics into a text vector (1032) and classifying the lyrics into a particular category (i.e., a second category) of the plurality of categories (act 1034), which may be performed by the natural language processing network 400 of FIG. 4.

The method 1000 also includes transforming the performer picture into an image vector (act 1042) and classifying the performer pictures into a particular category (a third category) of the plurality of categories (act 1044), which may be performed via the convolutional network 500 of FIG. 5. The method 1000 also includes transforming the performer video into a sequence of image vectors (act 1052) and classifying the sequence of image vectors into a particular category (i.e., a fourth category) of the plurality of categories (act 1054).

It is likely that the first category, the second category, the third category, and/or the fourth category match. However, when some of these categories do not match, suggestions to changes the music or adaptations of the song, or changes to the appearance and movement of the performer may be made to the user to cause the genre of the lyrics, the genre of the music, the genre of the performer appearance, and the genre of the performer emotion or movement match to each other.

Further, the method 1000 also includes accessing contextual information to identify a cultural paradigm of a current time (1060) and identifying one or more historical periods that have a matching cultural paradigm (1062). For example, a cultural paradigm may be a civil rights movement, a Black Lives Matter movement, an LGBTQ movement, a feminist movement, or an anti-war movement.

Based upon the identified first category of the audio of the song, the second category of the lyrics of the song, the third category of the performer image of the song, and/or the fourth category of the performer video of the song, and/or based on the identified one or more historical periods that have a matching cultural paradigm, one or more hit songs may be identified (act 1064). For example, the one or more hit songs may be the hit songs that are within the identified particular category or categories and/or that become hit songs during the identified one or more historical periods. Data associated with the identified one or more hit songs is then retrieved (act 1066). For each of the one or more hit songs, the data associated with the hit song includes at least one of (1) a performer picture of the hit song, (2) a performer video of the hit song, (3) lyrics of the hit song, or (4) audio of the hit song.

Thereafter, a similarity between the audio of the song and audio of each of the identified one or more hit songs is determined (act 1026), based upon which a first likelihood of the music of the song becoming hit song music may be determined (act 1028). The likelihood of the music becoming hit song music may be presented as a match/no-match binary result or a numeric likelihood score. Further, a similarity between the lyrics of the song and lyrics of each of the identified one or more hit songs is also determined (act 1036). Based upon the similarities between the lyrics of the song and the lyrics of the one or more hit songs, a second likelihood of the lyrics of the song becoming hit song lyrics may be determined (act 1038), which may also be a match/no-match binary result or a numeric likelihood score.

In some embodiments, the method 1000 also includes assigning a weight to each of the first likelihood and the second likelihood (act 1072) and weighting the first likelihood and the second likelihood to generate an overall likelihood of the music of the song becoming hit song music and/or an overall likelihood of the lyrics of the song becoming hit song lyrics (act 1074). In some embodiments, a relatedness between the lyrics or the music of the song and the current social paradigm may also be determined and assigned a weight. The overall likelihood of the music/lyrics becoming hit song music/lyrics may further be determined by weighting the relatedness of the music/lyrics of the song and the current social paradigm. Suggestions of changes to the lyrics, adaptation, and/or melody of the song may also be generated.

A report visualizing the overall likelihood of the music/lyrics becoming hit song music/lyrics and/or suggestion of changes to the lyrics, adaptation, and/or melody of the song may then be presented to a user (act 1076). In some embodiments, one or more user inputs may further be received to confirm or reject the overall results and/or the suggestions related to the song (act 1090).

In some embodiments, the method 1000 also includes determining a similarity between the performer image of the song and performer image of each hit song (act 1046) and determining a third likelihood of the performer becoming a hit song performer (act 1048). The method 1000 also includes determining a similarity between the performer video of the song and the performer video of each hit song (act 1056) and determining a fourth likelihood of the performer becoming a hit song performer (act 1058). Here, each of the third likelihood and the fourth likelihood of the performer becoming a hit song performer may be a match/no-match representation or a numeric likelihood score representation.

The method 1000 may also include assigning a weight to each of the third likelihood and the fourth likelihood of the performer becoming a hit song performer (act 1082) and weighting the third likelihood and the fourth likelihood to generate an overall likelihood of the performer becoming a hit song performer (act 1084). A report visualizing the overall likelihood of the performer becoming a hit song performer, suggestions to the performer, and/or suggestion of one or more alternative performer(s) may be generated (act 1086). In some embodiments, one or more user inputs may further be received to confirm or reject the overall results and/or the suggestions related to the performer (act 1090).

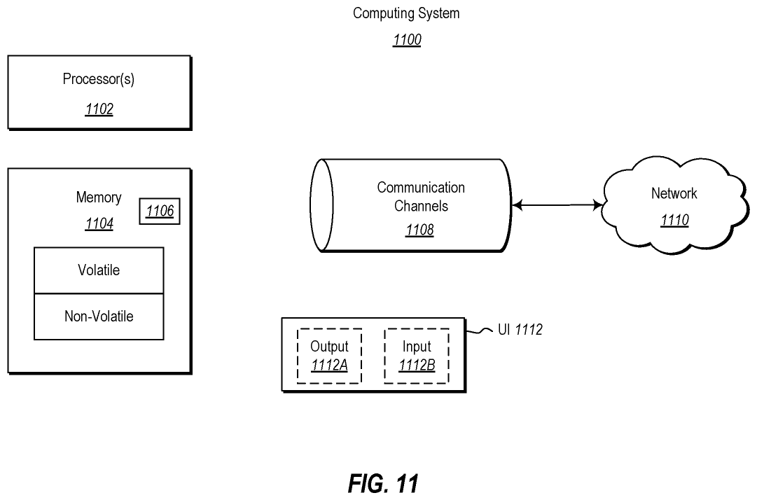

Finally, because the principles described herein may be performed in the context of a computing system (e.g., the engine 100) some introductory discussion of a computing system will be described with respect to FIG. 11.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 11, in its most basic configuration, a computing system 1100 typically includes at least one hardware processing unit 1102 and memory 1104. The processing unit 1102 may include a general-purpose processor and may also include a field-programmable gate array (FPGA), an application-specific integrated circuit (ASIC), or any other specialized circuit. The memory 1104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 1100 also has thereon multiple structures often referred to as an “executable component”. For instance, memory 1104 of the computing system 1100 is illustrated as including executable component 1106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 1104 of the computing system 1100. Computing system 1100 may also contain communication channels 1108 that allow the computing system 1100 to communicate with other computing systems over, for example, network 1110.

While not all computing systems require a user interface, in some embodiments, the computing system 1100 includes a user interface system 1112 for use in interfacing with a user. The user interface system 1112 may include output mechanisms 1112A as well as input mechanisms 1112B. The principles described herein are not limited to the precise output mechanisms 1112A or input mechanisms 1112B as such will depend on the nature of the device. However, output mechanisms 1112A might include, for instance, speakers, displays, tactile output, holograms and so forth. Examples of input mechanisms 1112B might include, for instance, microphones, touchscreens, holograms, cameras, keyboards, mouse or other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, handheld devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing system which may correspond to the computing system 1100 previously described. The computing systems of the remaining figures include various components or functional blocks that may implement the various embodiments disclosed herein as will be explained. The various components or functional blocks may be implemented on a local computing system or may be implemented on a distributed computing system that includes elements resident in the cloud or that implement aspect of cloud computing. The various components or functional blocks may be implemented as software, hardware, or a combination of software and hardware. The computing systems of the remaining figures may include more or less than the components illustrated in the figures and some of the components may be combined as circumstances warrant. Although not necessarily illustrated, the various components of the computing systems may access and/or utilize a processor and memory, such as processor 1102 and memory 1104, as needed to perform their various functions.

For the processes and methods disclosed herein, the operations performed in the processes and methods may be implemented in differing order. Furthermore, the outlined operations are only provided as examples, an some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable media having stored thereon computer-executable instructions that are structured such that, when executed by the one or more processors, cause the computing system to perform the following:
receive target song data associated with a target song performed by a performer, the target song data comprising at least one of (1) a target performer picture, (2) a target performer video, (3) target lyrics of the target song, or (4) target music audio of the target song;
transform the target music audio of the target song into a first frequency representation, representing a frequency spectrum of the target music audio over time;
transform the target lyrics of the target song into a first text vector via natural language processing;
access a current contextual information repository to identify a current cultural paradigm;
access a historical contextual information repository to identify one or more historical periods that have a historical cultural paradigm matching the current cultural paradigm;
identify one or more hit songs during the one or more historical periods;
retrieve hit song data associated with the one or more hit songs, the hit song data associated with each of the one or more hit songs comprising at least one of (1) a hit song performer picture, (2) a hit song performer video, (3) hit song lyrics of the hit song, or (4) hit song audio of the hit song;
for each of the one or more hit songs,
transform the hit song audio of the hit song into a second frequency representation, representing a frequency spectrum of the audio,
transform the hit song lyrics of the hit song into a second text vector via the natural language processing,
compare the first frequency representation of the hit song with the second frequency representation of the hit song to determine a similarity between the target audio of the target song and the hit song audio of the hit song, and
compare the first text vector of the target song and the second text vector of the hit song to determine a similarity between the target lyrics of the target song and the hit song lyrics of the hit song; and
based upon the determined similarities between the target lyrics and/or target melody of the target song and those of the one or more hit songs, determine at least one of (1) a likelihood of the target music audio of the target song becoming hit song music; or (2) a likelihood of the target lyrics of the target song becoming hit song lyrics.

2. The computing system of claim 1, wherein the determination of the likelihood of the target song becoming a hit song includes:
determining a first likelihood of the target song becoming a hit song based upon the similarities between the target audio of the target song and the hit song audio of the one or more hit songs;
determining a second likelihood of the target song becoming a hit song based upon the similarities between the target lyrics of the target song and the hit song lyrics of the one or more hit songs;
assigning a weight to each of the first likelihood and the second likelihood of the target song becoming a hit song; and
weighting the first likelihood and the second likelihood of the target song becoming a hit song based upon the assigned weights to determine (1) an overall likelihood of the target music audio of the target song becoming hit song music, or (2) the overall likelihood of the target lyrics of the target song becoming hit song lyrics.

3. The computing system of claim 1, wherein the executable instructions include instructions that are executable to configure the computer system to:
classify the target lyrics of the target song to a first particular category of a plurality of categories based upon the first text vector of the target song and a machine learning lyric classifier model; and
wherein retrieving the hit song data associated with the one or more hit songs includes:
identifying the one or more hit songs that belong to the first particular category, and
retrieving the hit song data associated with the one or more hit songs that belong to the particular category.

4. The computing system of claim 3, wherein the executable instructions include instructions that are executable to configure the computer system to:
analyze known song data associated with a set of known songs to train a machine learning lyrics classifier model, wherein:
for each known song of the set of known songs, the known song data associated with the known song includes known lyrics of the known song and a corresponding category of the plurality of categories that the known song belongs to.

5. The computing system of claim 4, wherein the executable instructions include instructions that are executable to configure the computer system to:
classify target song audio of the target song to a second particular category of a plurality of categories based upon the first frequency representation of the target song and a machine learning audio classifier model; and
wherein retrieving the hit song data associated with the one or more hit songs includes:
identifying the one or more hit songs that belong to the second particular category, and
retrieving the hit song data associated with the one or more hit songs that belong to the second particular category.

6. The computing system of claim 5, wherein the executable instructions include instructions that are executable to configure the computer system to:
analyze the known song data associated with the set of known songs to train the machine learning audio classifier model, wherein for each known song of the set of known songs, the known song data associated with the known song includes known audio of the known song and a corresponding category of the plurality of categories that the known song belongs to.

7. The computing system of claim 6, wherein when the first particular category and the second particular category do not match, the computing system suggests an alternative genre or an alternative adaptations for target music of the target song.

8. The computing system of claim 1, wherein the executable instructions include instructions that are executable to configure the computer system to:
transform the target performer picture into a first image vector using a first convolutional network;
for each of the identified one or more hit songs:
transform a hit song performer picture of the hit song into a second image vector using the first convolutional network, and
compare the first image vector of the target song performer picture with the second image vector of the hit song performer picture to determine a similarity between a target performer and a hit song performer; and
based upon the determined similarities between the target song performer and each of the hit song performers, determine a third likelihood of the target song performer becoming a hit song performer.

9. The computing system of claim 8, wherein each target song performer video includes a sequence of images; and
the executable instructions include instructions that are executable to configure the computer system to:
transform the sequence of images into a first sequence of image vectors using a second convolutional network;
for each of the identified one or more hit songs:
transform a hit song performer video of the hit song performer into a second sequence of image vectors using the second convolutional network, and
compare the first sequence of the image vectors of the target song performer video and the second sequence of the image vectors of the hit song performer video to determine a similarity between the target performer video and the hit song performer video; and
based upon the determined similarity between the target performer video and each of the hit song performer videos, determine a fourth likelihood of the target song performer becoming a hit song performer.

10. The computing system of claim 9, wherein the executable instructions include instructions that are executable to configure the computer system to:
assign a weight to each of the third likelihood and the fourth likelihood of the hit song performer becoming a hit song performer; and
based upon the assigned weights, weight the third likelihood, and the fourth likelihood to determine an overall likelihood of the hit song performer becoming a hit song performer.

11. A computing-implemented method, executed at one or more processors, the method comprising:
receiving target song data associated with a target song performed by a performer, the target song data comprising at least one of (1) a target performer picture, (2) a target performer video, (3) target lyrics of the target song, or (4) target music audio of the target song;
transforming the target music audio of the target song into a first frequency representation, representing a frequency spectrum of the target music audio over time;
transforming the target lyrics of the target song into a first text vector via natural language processing;
accessing a current contextual information repository to identify a current cultural paradigm;
accessing a historical contextual information repository to identify one or more historical periods that have a historical cultural paradigm matching the current cultural paradigm;
identifying one or more hit songs during the one or more historical periods;
retrieving hit song data associated with the one or more hit songs, the hit song data associated with each of the one or more hit songs comprising at least one of (1) a hit song performer picture, (2) a hit song performer video, (3) hit song lyrics of the hit song, or (4) hit song audio of the hit song;
for each of the one or more hit songs,
transforming the hit song audio of the hit song into a second frequency representation, representing a frequency spectrum of the audio,
transforming the hit song lyrics of the hit song into a second text vector via the natural language processing,
comparing the first frequency representation of the hit song with the second frequency representation of the hit song to determine a similarity between the target audio of the target song and the hit song audio of the hit song, and
comparing the first text vector of the target song and the second text vector of the hit song to determine a similarity between the target lyrics of the target song and the hit song lyrics of the hit song; and
based upon the determined similarities between the target lyrics and/or target melody of the target song and those of the one or more hit songs, determining at least one of (1) a likelihood of the target music audio of the target song becoming hit song music; or (2) a likelihood of the target lyrics of the target song becoming hit song lyrics.

12. The computer-implemented method of claim 11, wherein the determination of the likelihood of the target song becoming a hit song includes:
determining a first likelihood of the target song becoming a hit song based upon the similarities between the target audio of the target song and the hit song audio of the one or more hit songs;
determining a second likelihood of the target song becoming a hit song based upon the similarities between the target lyrics of the target song and the hit song lyrics of the one or more hit songs;
assigning a weight to each of the first likelihood and the second likelihood of the target song becoming a hit song; and
weighting the first likelihood and the second likelihood of the target song becoming a hit song based upon the assigned weights to determine (1) an overall likelihood of the target music audio of the target song becoming hit song music, or (2) the overall likelihood of the target lyrics of the target song becoming hit song lyrics.

13. The computer-implemented method of claim 11, further comprising:
classifying the target lyrics of the target song to a first particular category of a plurality of categories based upon the first text vector of the target song and a machine learning lyric classifier model; and
wherein retrieving the hit song data associated with the one or more hit songs includes:
identifying the one or more hit songs that belong to the first particular category, and
retrieving the hit song data associated with the one or more hit songs that belong to the particular category.

14. The computer-implemented method of claim 13, further comprising:
analyzing known song data associated with a set of known songs to train a machine learning lyrics classifier model, wherein:
for each known song of the set of known songs, the known song data associated with the known song includes known lyrics of the known song and a corresponding category of the plurality of categories that the known song belongs to.

15. The computer-implemented method of claim 14, further comprising:
classifying target song audio of the target song to a second particular category of a plurality of categories based upon the first frequency representation of the target song and a machine learning audio classifier model; and
wherein retrieving the hit song data associated with the one or more hit songs includes:
identifying the one or more hit songs that belong to the second particular category, and
retrieving the hit song data associated with the one or more hit songs that belong to the second particular category.

16. The computer-implemented method of claim 15, further comprising:
analyzing the known song data associated with the set of known songs to train the machine learning audio classifier model, wherein for each known song of the set of known songs, the known song data associated with the known song includes known audio of the known song and a corresponding category of the plurality of categories that the known song belongs to.

17. The computer-implemented method of claim 16, further comprising when the first particular category and the second particular category do not match, suggesting an alternative genre or an alternative adaptations for target music of the target song.

18. The computer-implemented method of claim 11, further comprising:
transforming the target performer picture into a first image vector using a first convolutional network;
for each of the identified one or more hit songs:
transforming a hit song performer picture of the hit song into a second image vector using the first convolutional network, and
comparing the first image vector of the target song performer picture with the second image vector of the hit song performer picture to determine a similarity between a target performer and a hit song performer; and
based upon the determined similarities between the target song performer and each of the hit song performers, determining a third likelihood of the target song performer becoming a hit song performer.

19. The computer-implemented method of claim 18, further comprising:
wherein each target song performer video includes a sequence of images; and
transforming the sequence of images into a first sequence of image vectors using a second convolutional network;
for each of the identified one or more hit songs:
transforming a hit song performer video of the hit song performer into a second sequence of image vectors using the second convolutional network, and
comparing the first sequence of the image vectors of the target song performer video and the second sequence of the image vectors of the hit song performer video to determine a similarity between the target performer video and the hit song performer video; and
based upon the determined similarity between the target performer video and each of the hit song performer videos, determining a fourth likelihood of the target song performer becoming a hit song performer.

20. A computer-readable media comprising one or more physical computer-readable storage media having stored thereon computer-executable instructions that, when executed at a processor, cause a computer system to perform a method, the method comprising:
receiving target song data associated with a target song performed by a performer, the target song data comprising at least one of (1) a target performer picture, (2) a target performer video, (3) target lyrics of the target song, or (4) target music audio of the target song;
transforming the target music audio of the target song into a first frequency representation, representing a frequency spectrum of the target music audio over time;
transforming the target lyrics of the target song into a first text vector via natural language processing;
accessing a current contextual information repository to identify a current cultural paradigm;
accessing a historical contextual information repository to identify one or more historical periods that have a historical cultural paradigm matching the current cultural paradigm;
identifying one or more hit songs during the one or more historical periods;
retrieving hit song data associated with the one or more hit songs, the hit song data associated with each of the one or more hit songs comprising at least one of (1) a hit song performer picture, (2) a hit song performer video, (3) hit song lyrics of the hit song, or (4) hit song audio of the hit song;
for each of the one or more hit songs,
transforming the hit song audio of the hit song into a second frequency representation, representing a frequency spectrum of the audio,
transforming the hit song lyrics of the hit song into a second text vector via the natural language processing,
comparing the first frequency representation of the hit song with the second frequency representation of the hit song to determine a similarity between the target audio of the target song and the hit song audio of the hit song, and
comparing the first text vector of the target song and the second text vector of the hit song to determine a similarity between the target lyrics of the target song and the hit song lyrics of the hit song; and
based upon the determined similarities between the target lyrics and/or target melody of the target song and those of the one or more hit songs, determining at least one of (1) a likelihood of the target music audio of the target song becoming hit song music; or (2) a likelihood of the target lyrics of the target song becoming hit song lyrics.
